(19) United States
(12) Patent Application Publication
(10) Pub. No.: US 2021/0304117 A1
(43) Pub. Date: Sep. 30, 2021

(54) MANAGEMENT DEVICE, MANAGEMENT METHOD, AND STORAGE MEDIUM

(71) Applicant: HONDA MOTOR CO., LTD., Tokyo (JP)

(72) Inventors: Yurie Kondo, Tokyo (JP); Koichi Ogura, Tokyo (JP); Toshikatsu Kuramochi, Tokyo (JP); Yusuke Kawada, Wako-shi (JP); Kensaku Yamamoto, Wako-shi (JP); Ryohei Iwaki, Wako-shi (JP)

(21) Appl. No.: 17/215,090

(22) Filed: Mar. 29, 2021

(30) Foreign Application Priority Data
Mar. 31, 2020 (JP) 2020-061907

(51) Int. Cl. G06Q 10/08

(52) U.S. Cl. CPC G06Q 10/083

(57) ABSTRACT

A management device is a management device that manages an operation of a luggage transportation vehicle which travels autonomously on a road without a driver getting on a vehicle and has luggage storages shielded by openable doors, and includes a receiver configured to receive application information related to transportation of the luggage with a designated delivery point, and an operation determiner configured to determine an operation of the luggage transportation vehicle based on at least the application information, in which the operation determiner brings, when a predetermined condition regarding a positional relationship between the luggage transportation vehicle and a recipient of the luggage is satisfied, the luggage transportation vehicle close to the recipient, and causing the luggage transportation vehicle to perform an operation for allowing the recipient to receive the luggage at a point different from the delivery point before the luggage transportation vehicle reaches the delivery point.

### CROSS-REFERENCE TO RELATED APPLICATION

Priority is claimed on Japanese Patent Application No. 2020-061907, filed Mar. 31, 2020, the content of which is incorporated herein by reference.

### BACKGROUND

### Field of the Invention

The present invention relates to a management device, a management method, and a storage medium.

### Description of Related Art

An invention for an unmanned delivery system that delivers luggage using an autonomous mobile device that can move autonomously and a server system that operates in conjunction with the autonomous mobile device has been disclosed (Japanese Unexamined Patent Application, First Publication No. 2018-058656).

### SUMMARY

The conventional technology simply delivers luggage to a delivery destination, and thus the convenience is not sufficient.

The present invention has been made in consideration of such circumstances, and one of the objects of the present invention is to provide a management device, a management method, and a storage medium that can improve convenience.

The management device, the management method, and the storage medium according to the present invention have adopted the following configuration.

(1): A management device according to one aspect of the present invention is a management device that manages an operation of a luggage transportation vehicle which travels autonomously on a road without a driver getting on a vehicle and has luggage storages shielded by openable doors, and includes a storage device configured to store a program, and a hardware processor, in which the hardware processor executes the program, thereby receiving application information related to transportation of luggage with a designated delivery point, determining an operation of the luggage transportation vehicle based on at least the application information, and bringing, when a predetermined condition regarding a positional relationship between the luggage transportation vehicle and a recipient of the luggage is satisfied, the luggage transportation vehicle close to the recipient, and causing the luggage transportation vehicle to perform an operation for allowing the recipient to receive the luggage at a point different from the delivery point before the luggage transportation vehicle reaches the delivery point at the time of determining the operation.

(2): In the aspect of (1) described above, the predetermined condition is that a terminal device of the recipient and a communication device mounted in the luggage transportation vehicle are able to communicate with each other without going through another device.

(3): In the aspect of (1) described above, the predetermined condition is that a position of the terminal device of the recipient and a position of the luggage transportation vehicle are within a predetermined range.

(4): In the aspect of (1) described above, when a size of the luggage is larger than a reference, the hardware processor causes the luggage transportation vehicle to move to the delivery point, and causes the luggage transportation vehicle to perform an operation for allowing the recipient to receive the luggage at the delivery point even if the positional relationship between the luggage transportation vehicle and the recipient satisfies a predetermined condition.

(5): In the aspect of (1) described above, when the hardware processor acquires content of an operation performed on a terminal device of the recipient or an operation device mounted in the luggage transportation vehicle by the recipient and the recipient desires to receive luggage at the delivery point, even if the positional relationship between the luggage transportation vehicle and the recipient satisfies a predetermined condition, the hardware processor causes the luggage transportation vehicle to move to the delivery point and causes the luggage transportation vehicle to perform an operation for allowing the recipient to receive the luggage at the delivery point.

(6): In the aspect of (5) described above, when the recipient desires to receive luggage at the delivery point and the hardware processor causes the luggage transportation vehicle to move to the delivery point and causes the luggage transportation vehicle to perform an operation for allowing the recipient to receive the luggage at the delivery point even if the positional relationship between the luggage transportation vehicle and the recipient satisfies a predetermined condition, the hardware processor causes the luggage transportation vehicle to move to the delivery point according to a pace of the recipient of the luggage.

(7): In the aspect of (1) described above, the hardware processor monitors a home status of the recipient, determines a delivery schedule of the luggage, and, when the luggage transportation vehicle is transporting luggage to a first recipient and the monitor determines that a second recipient who is scheduled to receive a delivery of luggage after the first recipient is at home, increases a delivery priority of the second recipient at the time of determining the schedule.

(8): In the aspect of (7) described above, the hardware processor monitors a home status of the recipient by acquiring security data of a security company.

(9): In the aspect of (7) described above, the hardware processor collects images of a person captured by cameras mounted in a plurality of the luggage transportation vehicles, and determines that the recipient is not at home when an image whose characteristics match the recipient is collected during a delivery of the luggage to the recipient.

(10): In the aspect of (7) described above, the hardware processor accumulates past home statuses in a storage, derives a probability of being at home for each time zone based on the accumulated home statuses, and determines whether the recipient is at home based on the probability of being at home.

(11): In the aspect of (7) described above, the hardware processor transmits information indicating that a delivery of the luggage to a terminal device of the recipient who is determined not to be at home will be skipped.

(12): A management method according to another aspect of the present invention includes, by a management device that manages an operation of a luggage transportation vehicle which travels autonomously on a road without a driver getting on a vehicle and has luggage storages shielded by openable doors, receiving application information related to transportation of the luggage with a designated delivery point, determining an operation of the luggage transportation vehicle based on at least the application information, and bringing, when a predetermined condition regarding a positional relationship between the luggage transportation vehicle and a recipient of the luggage is satisfied, the luggage transportation vehicle close to the recipient, and causing the luggage transportation vehicle to perform an operation for allowing the recipient to receive the luggage at a point different from the delivery point before the luggage transportation vehicle reaches the delivery point at the time of determining the operation.

(13): A storage medium according to still another aspect of the present invention is a computer-readable non-transitory storage medium that stores a program causing a processor of a management device that manages an operation of a luggage transportation vehicle which travels autonomously on a road without a driver getting on a vehicle and has luggage storages shielded by openable doors to execute receiving application information related to transportation of the luggage with a designated delivery point, determining an operation of the luggage transportation vehicle based on at least the application information, and bringing, when a predetermined condition regarding a positional relationship between the luggage transportation vehicle and a recipient of the luggage is satisfied, the luggage transportation vehicle close to the recipient, and causing the luggage transportation vehicle to perform an operation for allowing the recipient to receive the luggage at a point different from the delivery point before the luggage transportation vehicle reaches the delivery point at the time of determining the operation.

According to the aspects of (1) to (13), it is possible to improve convenience.

### BRIEF DESCRIPTION OF THE DRAWINGS

FIG. 1 is a configuration diagram of a transportation system including a management device.

FIG. 2 is a configuration diagram of a luggage transportation vehicle.

FIG. 3 is a diagram which shows an example of a structure related to a plurality of storages.

FIG. 4 is a configuration diagram of a management device.

FIG. 5 is a diagram which shows an example of content of user information.

FIG. 6 is a diagram which shows an example of a transportation service application screen for inputting application information, displayed on a display of a terminal device.

FIG. 7 is a diagram which shows an example of content of an application information list.

FIG. 8 is a diagram which shows an example of content of movement schedule information.

FIG. 9 is a diagram which shows a role of a collection center.

FIG. 10 is a diagram for describing a condition 1 and a condition 2.

FIG. 11 is a diagram which shows an example of a transportation service application screen that is displayed on the display of a terminal device and receives an input as to whether to desire a direct delivery.

FIG. 12 is a flowchart which shows an example of a flow of processing related to a direct delivery operation executed by an operation determiner.

### DESCRIPTION OF EMBODIMENTS

Hereinafter, embodiments of the management device, the management method, and the storage medium of the present invention will be described with reference to the drawings. A luggage transportation vehicle managed by the management device can autonomously travel on a road without a driver getting on the vehicle and has luggage storages that are shielded by doors that can be opened and closed.

A luggage transportation vehicle moves on a road to avoid obstacles on the road while recognizing a situation outside the vehicle according to a monitoring unit such as a camera, a radar device, and light detection and ranging (LIDAR), and, in principle, following a route instructed by the management device. The luggage transportation vehicle has wheels driven by, for example, a motor and moves on a road at a speed of about 10 [km]. A storage unit of the luggage transportation vehicle forms, for example, a space (a storage) for loading a plurality of pieces of luggage, which is separated from other spaces, and a plurality of users can load (carry in) each luggage therein.

The management device manages (controls) an operation of the luggage transportation vehicle. The management device is a device placed in a place different from the luggage transportation vehicle, and may communicates with the luggage transportation vehicle via a network, or some or all of the functions may be mounted in the luggage transportation vehicle. The management device generates transportation schedule information based on, for example, application information acquired by communication from a terminal device of the user. Then, the management device instructs the luggage transportation vehicle about a route and a stop place of the luggage transportation vehicle, an open/closed state of a door of the storage, and the like based on the transportation schedule information.

In the following description, the management device is a device placed in a place different from the luggage transportation vehicle (for example, a device in the form called a cloud server), and realizes the functions described above by communicating with the terminal device of the user or the luggage transportation vehicle via the network.

[Overall Configuration]

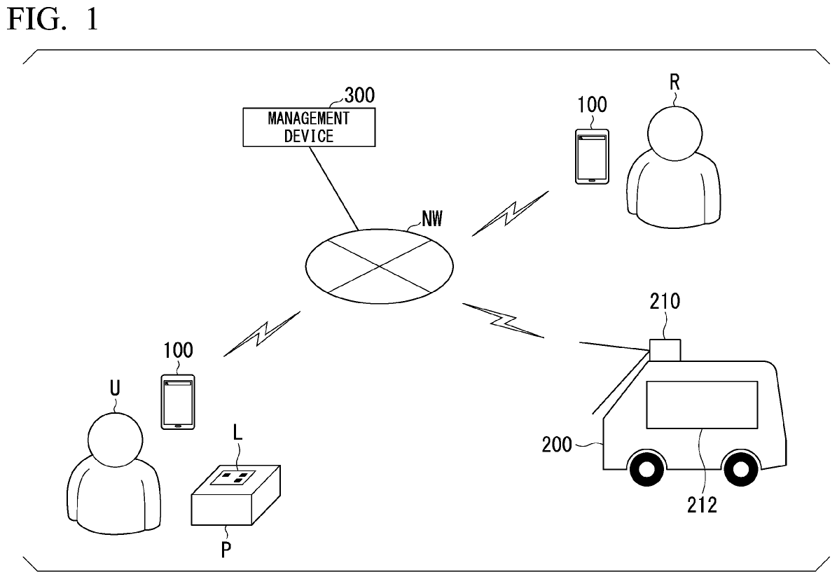

FIG. 1 is a configuration diagram of a transportation system 1 including a management device 300. The transportation system 1 includes one or more luggage transportation vehicles 200 and the management device 300. The management device 300 communicates with a terminal device 100 of a user U or a recipient R via the network NW. The network NW includes the Internet, a wide area network (WAN), a local area network (LAN), a public line, a provider device, a dedicated line, a wireless base station, and the like. The management device 300 communicates with the luggage transportation vehicles 200 via the network NW.

The user U transmits the application information for requesting transportation of luggage P to the management device 300 using the terminal device 100. On the luggage P, identification information of the luggage P and/or the user U is described, or a label L stored in an embedded IC tag or the like is attached thereto. “Being attached” means, for example, being affixed by a sticker.

The terminal device 100 is, for example, a smartphone, a tablet terminal, a personal computer, or the like. In the terminal device 100, an application program, a browser, or the like for using the service described above is activated to support a service to be described below. In the following description, it is assumed that the terminal device 100 is a smartphone and an application program (a transportation service application) for receiving a service is activated. In particular, the terminal device 100 needs to be a portable terminal device in a part related to a positional relationship between the luggage transportation vehicle and the recipient. The terminal device 100 has a GNSS receiver similar to that of the luggage transportation vehicle 200, and acquires positional information thereof. The transportation service application communicates with the management device 300 according to an operation of a user, sends application information from the user to the management device 300, or provides information based on the information received from the management device 300. The transportation service application uploads the positional information of the terminal device 100 to the management device 300. The application information is electronic information that requires the luggage transportation vehicle 200 to transport the luggage P over a designated section. The terminal device 100 may include a communication device for short-range wireless communication such as Bluetooth (a registered trademark). Short-range wireless communication is communication performed without going through other devices such as routers and base stations, and Wi-Fi may also be included therein. The recipient U also holds a terminal device 100 having a similar configuration.

[Luggage Transportation Vehicle]

The luggage transportation vehicle 200 includes a monitoring unit 210 such as a camera, a radar device, and LIDAR, and autonomously travels on a road as described above. The luggage transportation vehicle 200 may be provided with a display device 212. The display device 212 may have a touch panel function, or may have an embedded function of communicating with a non-contact type IC card.

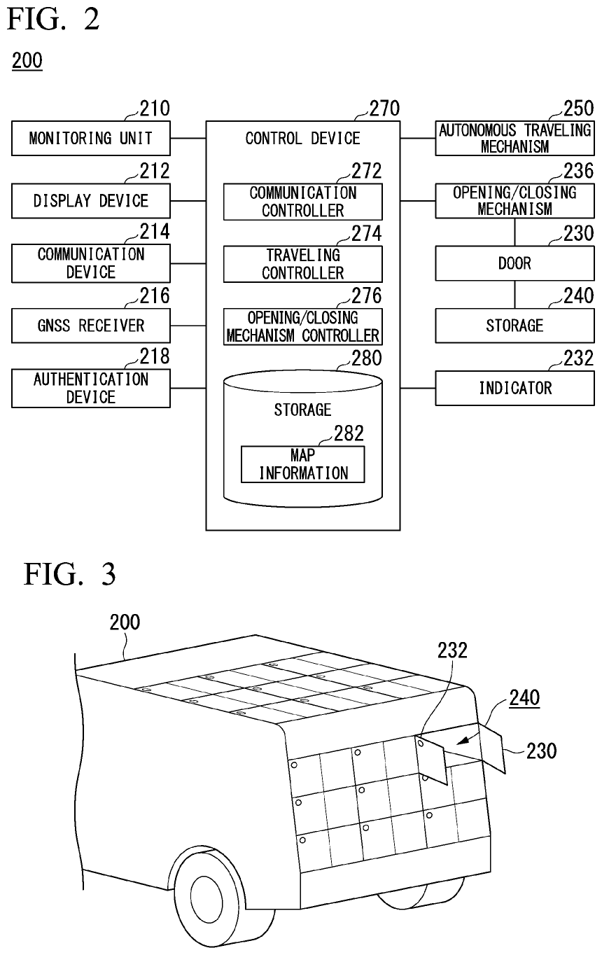

FIG. 2 is a configuration diagram of the luggage transportation vehicle 200. In addition to the monitoring unit 210 and display device 212 described above, the luggage transportation vehicle 200 includes a communication device 214, a GNSS receiver 216, an authentication device 218, an opening/closing mechanism 236, an autonomous traveling mechanism 250, and a control device 270.

The communication device 214 is, for example, a wireless communication module for connecting to the network NW or directly communicating with another vehicle or a terminal device of a pedestrian. The communication device 214 performs wireless communication based on Wi-Fi, Dedicated Short Range Communications (DSRC), Bluetooth, and other communication standards. As the communication device 214, a plurality of communication devices 214 according to purposes of use may be prepared.

The GNSS receiver 216 positions its own device (the luggage transportation vehicle 200) based on radio waves arriving from a GNSS satellite (for example, a GPS satellite). The GNSS receiver 216 outputs a result of the positioning to the control device 270.

The authentication device 218 is a device for confirming that a user who intends to carry the luggage P into the luggage transportation vehicle 200 is a legitimate user (authenticating the user). A legitimate user is a user who has made an agreement (reservation) regarding the transportation of luggage with the management device 300. The authentication device 218 may be any device as long as it has an authentication function, such as a short-range wireless communication device, a biometric authentication device, and a password input device. The authentication device 218 outputs a result of the authentication to the control device 270.

The opening/closing mechanism 236 is provided for each door 230, and includes a motor, an arm, and the like. The opening/closing mechanism 236 opens and closes the door 230 individually. For example, a switch for detecting that the door 230 has been manually closed is attached to the door 230. A locking mechanism may be provided instead of (or in addition to) the opening/closing mechanism 236. In this case, a door of a storage 240 used by the user U is unlocked, an indicator 232 (to be described below) lights up, and the user U manually opens and closes the door 230.

FIG. 3 is a diagram which shows an example of a structure related to a plurality of storages 240. The luggage transportation vehicle 200 has the plurality of storages 240. In the shown configuration, the luggage transportation vehicle 200 is provided with nine storages 240 that open on the upper surface side of the luggage transportation vehicle 200 and nine storages 240 that open on the rear surface side. The door 230 is provided in each of the storages 240. The door 230 is opened and closed, for example, in the form of hinged double doors, and causes at least a portion of the storage 240 to be exposed in an open state. An indicator 232 is attached corresponding to each storage 240 (for example, on a surface side of each door 230). The indicator 232 is configured by, for example, a light emitting diode (LED). The indicator 232 is caused to emit light by a carry-in/out controller 276 to indicate a carrying-in position of a carried-in luggage P or a position at which a carried-out luggage P is stored. It is agreed that each storage 240 stores one luggage P or the luggage P of a user U. For the luggage P stored in the storage 240, a user of the luggage P is recognized based on the storage 240 that stores the luggage, for example, at a collection center. Then, for example, by assigning a label to the luggage P by a worker at the collection center, a delivery destination (delivery point) can be specified in subsequent work.

An autonomous traveling mechanism 250 includes wheels, a driving force source such as a motor, an energy accumulation device such as a battery, and a steering mechanism. The autonomous traveling mechanism 250 moves the luggage transportation vehicle 200 in an arbitrary direction according to an instruction from the control device 270.

The control device 270 includes, for example, a communication controller 272, a traveling controller 274, and a carry-in/out controller 276. These components are realized by, for example, a hardware processor such as a central processing unit (CPU) executing a program (software). Some or all of these components may be realized by hardware (a circuit unit; including circuitry) such as large scale integration (LSI), an application specific integrated circuit (ASIC), a field-programmable gate array (FPGA), and a graphics processing unit (GPU), or may be realized by cooperation of software and hardware. The program may be stored in advance in a storage device such as a hard disk drive (HDD) or a flash memory (a storage device having a non-transitory storage medium), or may be stored in a removable storage medium (a non-transitory storage medium) such as a DVD or a CD-ROM and installed in the storage device by the storage medium being mounted in a drive device. The control device 270 has a storage 280 that stores map information 282. The storage 280 is an HDD, a flash memory, a ROM, a random access memory (RAM), or the like.

The communication controller 272 acquires information on a route from the management device 300 via the communication device 214 and outputs it to the traveling controller 274. The communication controller 272 uploads positional information indicating a position positioned by the GNSS receiver 216 to the management device 300 by using the communication device 214. The positional information is uploaded periodically, for example, in milliseconds to seconds.

The traveling controller 274 controls the autonomous traveling mechanism 250 such that the luggage transportation vehicle 200 travels on a route designated by the management device 300. For example, the traveling controller 274 matches the route acquired from the management device 300 with the map information 282 and an output of the monitoring unit 210, and determines a detailed route to be traveled by the luggage transportation vehicle 200. The traveling controller 274 causes the luggage transportation vehicle 200 to autonomously travel to avoid a contact with objects (including guardrails and curbs) whose position and speed are input from the monitoring unit 210, while traveling on the route in principle.

The traveling controller 274 causes the luggage transportation vehicle 200 to stop when it receives a stop instruction from the management device 300. Instead of this, when the route information includes information on a stop position, the traveling controller 274 may cause the luggage transportation vehicle 200 to stop when the result of the positioning of the GNSS receiver 216 and the stop position match. That is, the management device 300 gives a stop instruction or the information on a stop position to the traveling controller 274, and the traveling controller 274 causes the luggage transportation vehicle 200 to stop according to them. A position at which the luggage transportation vehicle 200 is caused to stop includes a position on a road. In particular, when the user U carries the luggage P into the storage 240 of the luggage transportation vehicle 200, the luggage transportation vehicle 200 stops on a road or in a parking lot.

The carry-in/out controller 276 drives, for example, the indicator 232 and the opening/closing mechanism 236 at a timing instructed by the management device 300.

[Management Device]

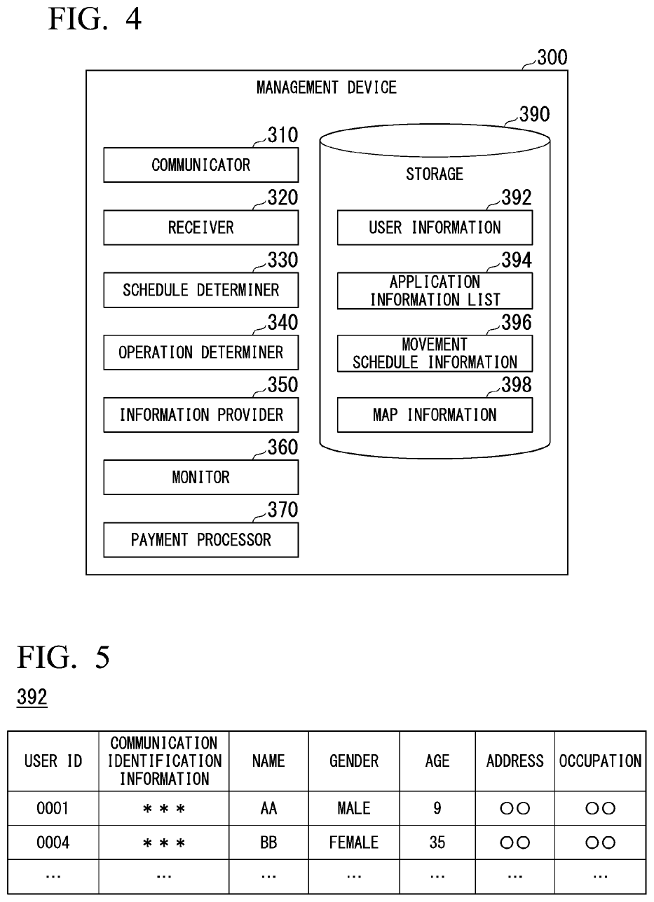

FIG. 4 is a configuration diagram of the management device 300. The management device 300 includes, for example, a communicator 310, a receiver 320, a schedule determiner 330, an operation determiner 340, an information provider 350, a monitor 360, and a payment processor 370. These components are realized, for example, by a hardware processor such as a CPU executing a program (software). Some or all of these components may be realized by hardware (a circuit unit; including circuitry) such as LSI, ASIC, FPGA, GPU, or may be realized by the cooperation of software and hardware. The program may be stored in advance in the storage device such as an HDD or a flash memory (a storage device including a non-transitory storage medium), or may be stored in a removable storage medium (a non-transitory storage medium) such as a DVD or a CD-ROM, and installed in the storage device by the storage medium being mounted in a drive device. The management device 300 may include a storage 390. The storage 390 is realized by a DVD, a random access memory (RAM), a flash memory, or the like. Information such as user information 392, an application information list 394, movement schedule information 396, and map information 398 is stored in the storage 390.

FIG. 5 is a diagram which shows an example of content of the user information 392. The user information 392 is, for example, information in which information such as communication identification information, name, gender, age, address, and occupation is associated with a user ID that is identification information of a user. Each item of the user information 392 is registered in advance at the time of subscribing to a service managed by the management device 300. The communication identification information is information required to transmit information to a terminal device 100, and is information such as an application ID, an Internet Protocol (IP) address, a Media Access Control (MAC) address, and an email address assigned to an application program.

The communicator 310 is, for example, a network card for connecting to the network NW. The communicator 310 communicates with the terminal device 100 and the vehicle 200 via the network NW.

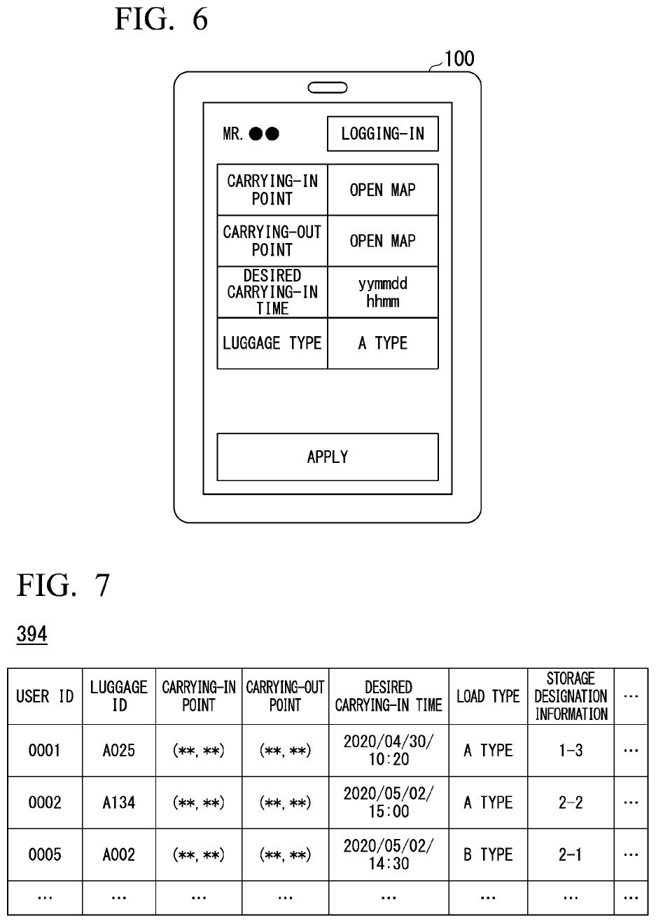

The receiver 320 acquires (receives) application information issued from the terminal device 100 of a user via the communicator 310, and adds it to the application information list 394. FIG. 6 is a diagram which shows an example of a transportation service application screen for inputting application information, displayed on a display of the terminal device 100. As shown in FIG. 6, on the transportation service application screen, it is possible to input a carrying-in point, a delivery point, a desired carrying-in time, a luggage type indicating the size and shape of luggage, and the like, and information input by the user U is transmitted to the management device 300 as application information. The carrying-in point and the delivery point are input by, for example, the terminal device 100 displaying a map and the user U designating a point on the map.

FIG. 7 is a diagram which shows an example of content of the application information list 394. The application information list 394 is, for example, information in which a user ID of a user who has sent application information, a luggage ID that is identification information of luggage, a carrying-in point that is a start point of a section related to the transportation of luggage and a delivery point that is an end point thereof, a desired carrying-in time, a luggage type, a storage designation information, and the like are associated with each other. A set of a user ID, a luggage ID, a carrying-in point, a delivery point, a desired carrying-in time, and a luggage type, related to one piece of application information is referred to as a record. A luggage ID is assigned by the receiver 320. The application information is information in an arbitrary form, which includes content required to generate a record. The storage designation information is information indicating which storage 240 is allocated. In FIG. 7, “1” of “1-3” indicates that it is one of the storages 240 that open on the upper surface side of the luggage transportation vehicle 200, and “−3” indicates which one of the nine storages on the upper surface side. “2” of “2-2” indicates that it is one of the storages 240 that open on the rear surface side of the luggage transportation vehicle 200, and “−2” indicates which one of the nine storages on the rear surface side.

The storage designation information is determined by, for example, the schedule determiner 330. When the schedule determiner 330 determines the storage designation information in response to application information received from the user U, the schedule determiner 330 transmits details of the determination to the terminal device 100 of a user. The terminal device 100 displays information indicating the details of the determination. As a result, the user U can recognize in advance a position of the storage 240 to store the luggage P.

When a record of new application information is added to the application information list 394, the schedule determiner 330 refers to a list of the luggage transportation vehicles 200 (not shown) and the movement schedule information 396, and selects a luggage transportation vehicle 200 to be used by the user U related to application information among the plurality of luggage transportation vehicles 200. Then, the storage designation information is determined as described above, and is transmitted to the terminal device 100 of the user U.

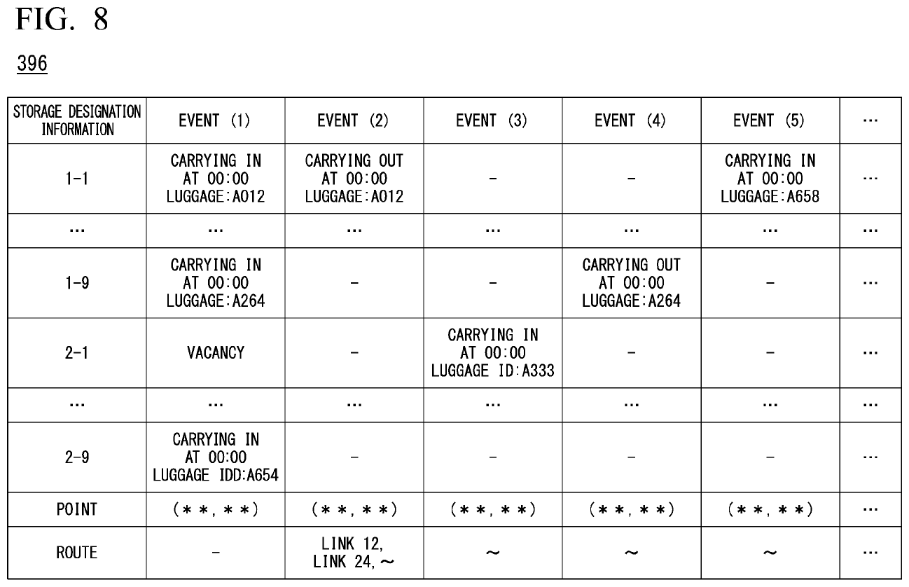

FIG. 8 is a diagram which shows an example of content of the movement schedule information 396. The movement schedule information 396 has a daily schedule set for each of the luggage transportation vehicles 200 as one unit. The movement schedule information 396 is information in which an estimated time, information indicating carrying-in or carrying-out, a luggage ID of the luggage P to be transported, a point at which carrying-in or carrying-out is performed, information on a route between points (for example, it is assumed that the route is a route from a previous event to a current event), and the like are associated with an event in which carrying-in or carrying-out is performed for each of the storages 240. The route is expressed by, for example, links in the map information 398 arranged in order. For example, the schedule determiner 330 roughly groups records of application information by date, time zone, and region, sets some movement patterns in which a plurality of carrying-in points and desired carrying-in times are arranged in order, extracts a movement pattern having the lowest movement cost with reference to the map information 398, and adds it to the movement schedule information 396. As for a calculation method and an evaluation method of the movement cost, various methods are known in a field of a navigation system, and thus the description thereof will be omitted.

The operation determiner 340 transmits an operation instruction to the luggage transportation vehicle 200 using a communicator 310 based on the movement schedule information 396 as described above. That is, the operation determiner 340 determines an operation of the luggage transportation vehicle 200 based on the movement schedule information 396 generated based on application information received by the receiver 320. The operation of the luggage transportation vehicle 200 determined by the operation determiner 340 includes a stop instruction at a route, a carrying-in point or a delivery point (a stop timing may be instructed, or a point may be instructed mainly depending on determination by the luggage transportation vehicle 200), and content such as which storage 240 to be made empty at a carrying-in point or a delivery point.

As shown in FIG. 8, with respect to a storage 240 whose storage designation information is “1-1,” the movement schedule information 396 is set such that luggage P whose luggage ID is “A012” is carried in at an event (1) and is carried out at an event (2) after transportation, and luggage P whose luggage ID is “A658” is carried in at an event (5). Luggage P whose luggage ID is “A333” is carried in a storage 240 whose storage designation information is “2-1” at an event (3) while the luggage P is delivered by another storage 240.

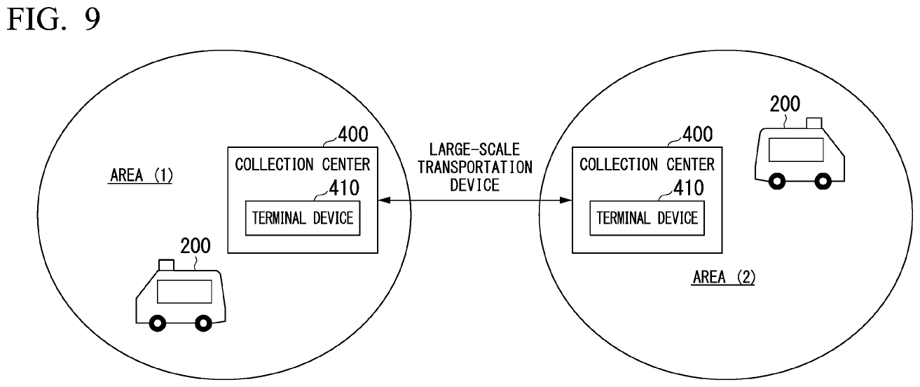

The luggage P may be transported via a collection center during the transportation. FIG. 9 is a diagram which shows a role of a collection center 400. The collection center 400 is provided for each arbitrarily divided area. The luggage transportation vehicle 200 may complete a collection to a delivery within an area without going through the collection center 400, but, when a delivery outside the area is designated, it carries out the luggage P by delivering the luggage P up to the collection center 400. The luggage P is transported between the collection center 400 and the collection center 400 by a large-scale transportation device such as a large truck or a railroad.

Then, at the collection center 400 that is a destination of the transportation, the luggage P is carried into the luggage transportation vehicle 200 and transported to a delivery destination. A carrying-in point and a carrying-out point in the movement schedule information 396 may be the collection center 400. In particular, the luggage P whose luggage IDs are A012, A264, and A654 is carried in at the event (1) of FIG. 8 due to work at the collection center 400.

The information provider 350 causes the terminal device 100 of the user U to provide positional information and route information of the luggage transportation vehicle 200. The information provider 350 transmits the positional information uploaded using the communication device 214 by the communication controller 272 of the luggage transportation vehicle 200 and the route information described in the movement schedule information 396 to the terminal device 100 using the communicator 310. The information provider 350 transmits, for example, information for displaying an image indicating the positional information and route information by superimposing the image on a map image to the terminal device 100. The information provider 350 transmits information indicating that the delivery of the luggage P to the terminal device 100 of a recipient determined not to be at home by the monitor 360 to be described below will be skipped.

Functions of the monitor 360 will be described below.

The payment processor 370 performs processing for collecting charges from the user U. For example, the payment processor 370 cooperates with a credit card or electronic money management server to collect charges from the user U.

[Processing at the Time of Recognizing Recipient]

Hereinafter, processing when the luggage transportation vehicle 200 and the recipient of the luggage P approach each other on the way to the delivery point will be described. The operation determiner 340 brings the luggage transportation vehicle 200 close to the recipient and causes the luggage transportation vehicle 200 to perform an operation for allowing the recipient to receive the luggage P at a point different from the delivery point when a predetermined condition regarding the positional relationship between the luggage transportation vehicle 200 and the recipient of the luggage P is satisfied before the luggage transportation vehicle 200 reaches the delivery point. Hereinafter, the “operation for bringing the luggage transportation vehicle 200 close to the recipient and allowing the recipient to receive the luggage P at a point different from the delivery point” is referred to as a “direct delivery operation.” To provide such a function, the terminal device 100 of the recipient is provided with a function of a recipient menu among functions provided by a transportation service application, and realizes various services to be described below.

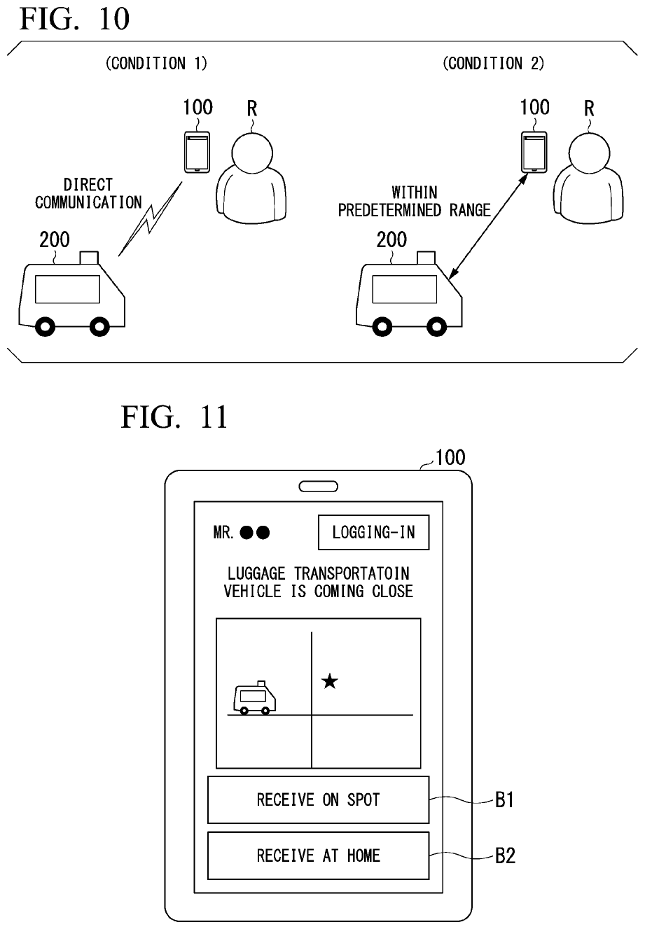

The predetermined condition is either or both of the following condition 1 and condition 2. That is, the operation determiner 340 may cause the luggage transportation vehicle 200 to perform the direct delivery operation on an assumption that the predetermined condition is satisfied only when the condition 1 is satisfied, may cause the luggage transportation vehicle 200 to perform the direct delivery operation on an assumption that the predetermined condition is satisfied only when the condition 2 is satisfied, and may cause the luggage transportation vehicle 200 to perform the direct delivery operation on an assumption that the predetermined condition is satisfied only when any one of the condition 1 and the condition 2 is satisfied. FIG. 10 is a diagram for describing the condition 1 and condition 2.

(Condition 1)

The terminal device 100 of the recipient and the communication device 214 mounted in the luggage transportation vehicle 200 can communicate with each other without going through another device (by short-range wireless communication).

(Condition 2)

The position of the terminal device 100 of the recipient and the position of the luggage transportation vehicle 200 are within a predetermined range.

Regarding the condition 1, for example, when a search signal is periodically transmitted from the luggage transportation vehicle 200 and there is a reply from a luggage transportation application of the terminal device 100 of the recipient, information indicating that there is a reply is transmitted from the luggage transportation vehicle 200 to the management device 300. The operation determiner 340 determines that the condition 1 is satisfied by receiving the information.

Regarding the condition 2, the predetermined range may mean that an absolute distance between the position of the recipient and the position of the luggage transportation vehicle 200 is within a predetermined distance, or may mean that a road distance when applied to the map information is within a predetermined distance. The position of the recipient is ascertained based on the positional information uploaded from the terminal device 100 of the recipient, and the position of the luggage transportation vehicle 200 is ascertained based on the positional information uploaded from the luggage transportation vehicle 200.

However, the operation determiner 340 does not cause the luggage transportation vehicle 200 to perform the direct delivery operation even when a predetermined condition is satisfied when the following exceptional event occurs.

(Exceptional event 1)

The size of the luggage P ascertained from the “luggage type” obtained by referring to the application information list 394 is larger than a reference. In this case, it is difficult for the recipient to carry the luggage P and move to his or her home.

(Exceptional event 2)

Referring to content of an operation performed by the recipient on an operation device mounted on the terminal device 100 or the luggage transportation vehicle 200 (not shown, a touch panel of the display device 212 may function as the operation device as described above), the recipient desires to receive luggage at the delivery point.

FIG. 11 is a diagram showing an example of a transportation service application screen that is displayed on the display of the terminal device 100 and receives an input as to whether a direct delivery is desired. As shown in FIG. 11, on this transportation service application screen, it is presented to a recipient together with map information that the luggage transportation vehicle 200 is coming close, for example, it is possible to input whether the recipient desires a delivery to a point where the recipient is at that time (hereinafter, a direct delivery), and information input by the recipient is transmitted to the management device 300. For example, if the recipient operates a button B1 displayed as “receive on the spot,” information indicating that the recipient desires a direct delivery is sent to the management device 300, and, if the recipient operates a button B2 displayed as “receive at home,” information indicating that a direct delivery is not desired is transmitted to the management device 300.

When it is decided to cause the luggage transportation vehicle 200 to perform the direct delivery operation, the operation determiner 340 first determines whether it is possible to cause the luggage transportation vehicle 200 to stop at the point where the recipient is, changes a destination of the luggage transportation vehicle 200 to the point if possible or to a stoppable place near the recipient if not possible, and regenerates a route of the luggage transportation vehicle 200. The stoppable place is a place that satisfies a condition for vehicle stopping, such as a place on a road having a width enough for both a vehicle and a pedestrian to pass through when the luggage transportation vehicle 200 is stopped. Then, when the recipient is recognized by the monitoring unit 210 or the communication device 214 while communicating with the luggage transportation vehicle 200, the luggage transportation vehicle 200 is moved to a vicinity of the recognized recipient and stopped, and the door 230 of a storage 240 in which the luggage P for the recipient is stored is opened or unlocked. As a result, the direct delivery operation is realized.

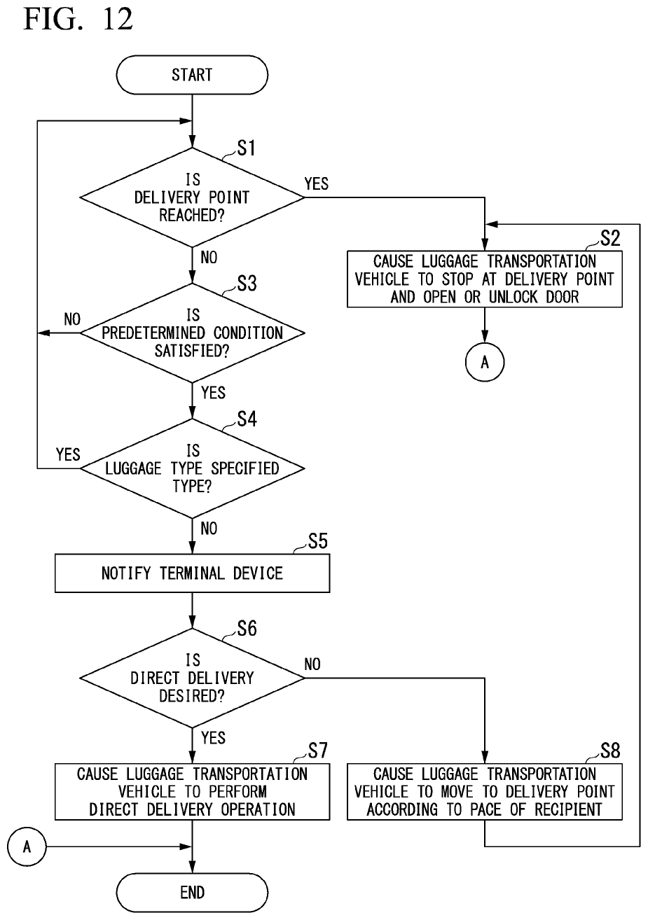

FIG. 12 is a flowchart which shows an example of a flow of processing related to the direct delivery operation executed by the operation determiner 340. The processing of this flowchart is started when the luggage transportation vehicle 200 starts moving toward a delivery point to a recipient.

First, the operation determiner 340 determines whether the luggage transportation vehicle 200 has reached the delivery point (step S1). When it is determined that the luggage transportation vehicle 200 has reached the delivery point, the operation determiner 340 causes the luggage transportation vehicle 200 to stop at the delivery point and opens or unlocks the door 230 (step S2).

If it is not determined that the luggage transportation vehicle 200 has reached the delivery point, the operation determiner 340 determines whether the “predetermined condition” described above is satisfied (step S3). When it is determined that the predetermined condition is satisfied, the operation determiner 340 determines whether the luggage type of the luggage P related to the delivery point is the specified type (step S4). The specified type is a luggage type whose size is equal to or larger than a reference.

When the predetermined condition is not satisfied, or when the luggage type is the specified type, the processing is returned to step S1. When the predetermined condition is satisfied and the luggage type is not the specified type, the operation determiner 340 notifies the terminal device 100 of information indicating that a direct delivery is possible (step S5; FIG. 11). Then, when the operation determiner 340 obtains the information indicating that a direct delivery is desired from the terminal device 100, the operation determiner 340 causes the luggage transportation vehicle 200 to perform the direct delivery operation (step S7). On the other hand, when the information indicating that a direct delivery is desired cannot be obtained from the terminal device 100, the operation determiner 340 causes the luggage transportation vehicle 200 to move to the delivery point according to the pace of the recipient (step S8), and then performs the processing of step S2. “Moving to the delivery point according to the pace of the recipient” means, for example, to cause the luggage transportation vehicle 200 to move in the same direction as the recipient while maintaining a constant positional relationship between the recipient and the luggage transportation vehicle 200. More specifically, when a state in which a front end of the luggage transportation vehicle 200 is positioned right next to the recipient, or a state in which the front end of the luggage transportation vehicle 200 is positioned about 1 [m] behind the recipient is maintained, it means that the luggage transportation vehicle 200 is caused to move in the same direction as the recipient. When a predetermined time has elapsed without obtaining information from the terminal device 100 in step S6, the processing may be returned to step S1.

By such processing, the management device 300 can improve the convenience especially for the recipient. In this type of service, it is not possible to designate a detailed delivery time, or, even if a detailed delivery time can be designated, the delivery time is generally shifted according to a road condition, and it is assumed that the luggage transportation vehicle 200 has arrived and the service is treated as being absent while the recipient is out for a little business. If the service is treated as absence, there is a need for a re-delivery, which will increase a burden on a service provider side. On the other hand, according to the processing of the embodiment, when the luggage transportation vehicle 200 passes near the recipient, delivery can be completed on the spot unless the luggage P is large, and thus there is a great advantage for both parties.

[About Function and Usage of Monitor]

Hereinafter, the monitor 360 will be described. The monitor 360 monitors a home status of a recipient. The monitor 360 monitors the home status of a recipient by, for example, any of the following methods.

(Monitoring method 1)

The monitor 360 acquires, for example, security data of a security company via a network NW, and monitors the home status of a recipient based on the acquired security data. Since the security data includes data indicating a presence/absence for each time zone described as, for example, “0:00 to 0:00: Absence, during security,” the monitor 360 determines that the recipient is at home when a current time does not correspond to the time zone of absence.

(Monitoring method 2)

The monitor 360 collects images of a person captured by cameras mounted in the plurality of luggage transportation vehicles 200, and determines that the recipient is not at home when an image matching the characteristics of the recipient is collected during a delivery of the luggage P to the recipient. Since various methods are known for characteristics extraction of person images, description thereof will be omitted.

The monitor 360 may accumulate the past home statuses determined as described above in the storage 390, derive a probability of being at home for each time zone based on the accumulated home statuses, and determine (estimate) whether the recipient is at home based on the probability of being at home. A known statistical method may be used in the processing.

Then, when the luggage transportation vehicle 200 is transporting luggage to a first recipient, and a second recipient who is scheduled to receive a delivery of luggage after the first recipient is determined to be at home by the monitor 360, the schedule determiner 330 increases a delivery priority of the second recipient. “Increasing the delivery priority” means, for example, advancing a delivery order to perform a delivery first.

The information provider 350 transmits information indicating that the delivery of the luggage P to the terminal device 100 of a recipient (a recipient who is scheduled to receive a delivery of the luggage P next) determined not to be at home by the monitor 360 will be skipped.

These types of processing can reduce a probability of cases of being treated as absent, and can bring benefits to both a recipient and a service provider.

According to the embodiment described above, it is possible to improve convenience.

The embodiment described above can be expressed as follows.

A management device is a management device that manages an operation of a luggage transportation vehicle which travels autonomously on a road without a driver getting on a vehicle and has luggage storages shielded by openable doors, and includes a storage device configured to store a program, and a hardware processor, the hardware processor executes the program, thereby receiving application information related to transportation of the luggage with a designated delivery point, determining an operation of the luggage transportation vehicle based on at least the application information, and bringing, when a predetermined condition regarding a positional relationship between the luggage transportation vehicle and a recipient of the luggage is satisfied, the luggage transportation vehicle close to the recipient, and causing the luggage transportation vehicle to perform an operation for allowing the recipient to receive the luggage at a point different from the delivery point before the luggage transportation vehicle reaches the delivery point at the time of determining the operation.

Although the embodiments for carrying out the present invention have been described above using the embodiments, the present invention is not limited to these embodiments, and various modifications and substitutions are made within a range not departing from the gist of the present invention.

### EXPLANATION OF REFERENCES

100 Terminal device
200 Luggage transportation vehicle
210 Monitoring unit
212 Display device
214 Communication device
216 GNSS receiver
218 Authentication device
230 Door
232 Indicator
236 Opening/closing mechanism
240 Storage
250 Autonomous traveling mechanism
270 Control device
272 Communication controller
274 Traveling controller
276 Opening/closing mechanism controller
280 Storage
282 Map information
300 Management device
310 Communicator
320 Receiver
330 Schedule determiner
340 Operation determiner
350 Information provider
360 Monitor
370 Payment processor
390 Storage
392 User information
394 Application information list
396 Movement schedule information
398 Map information
U User
R Recipient
P Luggage

What is claimed is:

1. A management device that manages an operation of a luggage transportation vehicle which travels autonomously on a road without a driver getting on a vehicle and has luggage storages shielded by openable doors, comprising:
a storage device configured to store a program; and
a hardware processor,
wherein the hardware processor executes the program, thereby receiving application information related to transportation of the luggage with a designated delivery point, determining an operation of the luggage transportation vehicle based on at least the application information, and bringing, when a predetermined condition regarding a positional relationship between the luggage transportation vehicle and a recipient of the luggage is satisfied, the luggage transportation vehicle close to the recipient, and causing the luggage transportation vehicle to perform an operation for allowing the recipient to receive the luggage at a point different from the delivery point before the luggage transportation vehicle reaches the delivery point at the time of determining the operation.

2. The management device according to claim 1,
wherein the predetermined condition is that a terminal device of the recipient and a communication device mounted in the luggage transportation vehicle are able to communicate with each other without going through another device.

3. The management device according to claim 1,
wherein the predetermined condition is that a position of the terminal device of the recipient and a position of the luggage transportation vehicle are within a predetermined range.

4. The management device according to claim 1,
wherein, when a size of the luggage is larger than a reference, the hardware processor causes the luggage transportation vehicle to move to the delivery point, and causes the luggage transportation vehicle to perform an operation for allowing the recipient to receive the luggage at the delivery point even if the positional relationship between the luggage transportation vehicle and the recipient satisfies a predetermined condition.

5. The management device according to claim 1,
wherein, when the hardware processor acquires content of an operation performed on a terminal device of the recipient or an operation device mounted in the luggage transportation vehicle by the recipient and the recipient desires to receive luggage at the delivery point, even if the positional relationship between the luggage transportation vehicle and the recipient satisfies a predetermined condition, the hardware processor causes the luggage transportation vehicle to move to the delivery point and causes the luggage transportation vehicle to perform an operation for allowing the recipient to receive the luggage at the delivery point.

6. The management device according to claim 5,
wherein, when the recipient desires to receive luggage at the delivery point and the hardware processor causes the luggage transportation vehicle to move to the delivery point and causes the luggage transportation vehicle to perform an operation for allowing the recipient to receive the luggage at the delivery point even if the positional relationship between the luggage transportation vehicle and the recipient satisfies a predetermined condition, the hardware processor causes the luggage transportation vehicle to move to the delivery point according to a pace of the recipient of the luggage.

7. The management device according to claim 1,
wherein the hardware processor monitors a home status of the recipient, determines a delivery schedule of the luggage, and, when the luggage transportation vehicle is transporting luggage to a first recipient and the monitor determines that a second recipient who is scheduled to receive a delivery of luggage after the first recipient is at home, increases a delivery priority of the second recipient at the time of determining the schedule.

8. The management device according to claim 7,
wherein the hardware processor monitors the home status of the recipient by acquiring security data of a security company.

9. The management device according to claim 7,
wherein the hardware processor collects images of a person captured by cameras mounted in a plurality of the luggage transportation vehicles, and determines that the recipient is not at home when an image whose characteristics match the recipient is collected during a delivery of the luggage to the recipient.

10. The management device according to claim 7,
wherein the hardware processor accumulates past home statuses in a storage, derives a probability of being at home for each time zone based on the accumulated home statuses, and determines whether the recipient is at home based on the probability of being at home.

11. The management device according to claim 7,
wherein the hardware processor transmits information indicating that a delivery of the luggage to a terminal device of the recipient who is determined not to be at home will be skipped.

12. A management method comprising:
by a management device that manages an operation of a luggage transportation vehicle which travels autonomously on a road without a driver getting on a vehicle and has luggage storages shielded by openable doors,
receiving application information related to transportation of the luggage with a designated delivery point,
determining an operation of the luggage transportation vehicle based on at least the application information, and
bringing, when a predetermined condition regarding a positional relationship between the luggage transportation vehicle and a recipient of the luggage is satisfied, the luggage transportation vehicle close to the recipient, and causing the luggage transportation vehicle to perform an operation for allowing the recipient to receive the luggage at a point different from the delivery point before the luggage transportation vehicle reaches the delivery point at the time of determining the operation.

13. A computer-readable non-transitory storage medium that stores a program causing a processor of a management device that manages an operation of a luggage transportation vehicle which travels autonomously on a road without a driver getting on a vehicle and has luggage storages shielded by openable doors to execute
receiving application information related to transportation of the luggage with a designated delivery point,
determining an operation of the luggage transportation vehicle based on at least the application information, and
bringing, when a predetermined condition regarding a positional relationship between the luggage transportation vehicle and a recipient of the luggage is satisfied, the luggage transportation vehicle close to the recipient, and causing the luggage transportation vehicle to perform an operation for allowing the recipient to receive the luggage at a point different from the delivery point before the luggage transportation vehicle reaches the delivery point at the time of determining the operation.
